(19) United States
(12) Patent Application Publication
(10) Pub. No.: US 2025/0045733 A1
(43) Pub. Date: Feb. 6, 2025

(54) SYSTEM AND METHOD FOR ENCAPSULATING TRUST MECHANISMS INTO NON-FUNGIBLE TOKENS

(71) Applicant: UREEQA Inc., Kitchener (CA)

(72) Inventor: Harsch KHANDELWAL, Kitchener (CA)

(21) Appl. No.: 18/713,274

(22) PCT Filed: Nov. 25, 2022
(86) PCT No.: PCT/CA2022/051735

§ 371 Date: May 24, 2024

Related U.S. Application Data
(60) Provisional application No. 63/283,354, filed on Nov. 26, 2021.

(51) Int. Cl. G06Q 20/36; G06Q 20/38; H04L 9/32

(52) U.S. Cl. CPC G06Q 20/3672; G06Q 20/3674; G06Q 20/389; H04L 9/3213; H04L 9/3218

(57) ABSTRACT

The disclosure is directed at a method and system for the providing trust and transparency relating to non-fungible token (NT) ownership.

### CROSS-REFERENCE TO OTHER APPLICATIONS

The current disclosure claims priority from U.S. Provisional Application No. 63/283,354 filed Nov. 26, 2021 which is hereby incorporated by reference.

### FIELD

The present disclosure relates generally to non-fungible tokens (NFTs) and, more specifically, to a system and method for providing trust and transparency relating to NFT ownership.

### BACKGROUND

As the world of technology grows, different technology products and offerings have been coming to the market. These products and offerings include non-fungible tokens (NFTs). A NFT is a unique digital identifier that is recorded in a blockchain, and that is used to certify authenticity and ownership. The ownership of an NFT is recorded in the blockchain and can be transferred by the owner, allowing NFTs to be sold and traded. Unfortunately, the demand for NFTs has been accompanied by fraudulent activity.

In the digital age, it is easy for fraudsters to copy creative works like photographs, videos and audio and claim them as their own. These copies create risks for buyers, sellers and owners of creative works associated with NFTs. In many examples, an individual can download the creative work associated with an NFT that was just sold. They can then use that same photo to mint a new NFT, and sell it again. As such, there are vulnerabilities, trust gaps, and risks in the NFT market.

Therefore, there is provided a novel system and method for providing trust and transparency relating to NFT ownership.

### SUMMARY

In one aspect of the disclosure, there is provided a method of encapsulating trust mechanisms within a non-fungible token (NFT) including receiving a request for generating a NFT relating to a creative work; validating the creative work; generating a validated NFT based on a positive validation of the creative work; and writing the validated NFT to a blockchain.

In another aspect, the disclosure further includes generating at least one collectible NFT based on the validated NFT; and writing the at least one collectible NFT to the blockchain. In a further aspect, after validating the creative work, generating a package of proof based on the validation. In yet another aspect, generating a package of proof includes combining the creative work, supporting documents and validation information into the package of proof. In another aspect, generating a validated NFT includes transmitting the package of proof to a NFT validated smart control component; and generating the validated NFT based on the package of proof.

In a further aspect, generating at least one collectible NFT based on the validated NFT includes receiving utility information associated with the validated NFT; and generating a collectible NFT based on the utility information and a package of proof.

In another aspect of the disclosure, there is provided a method of authenticating a non-fungible token (NFT) of interest including receiving a request for authenticating the NFT of interest; determining if the NFT of interest is written to a blockchain; and displaying proof to a user of NFT authenticity if the NFT is written to the blockchain.

In a further aspect, receiving a request for authenticating the NFT includes sensing connection of a cryptocurrency wallet; and searching the crytopcurrency wallet for the NFT of interest. In yet another aspect, the method includes providing notification to a user that the NFT of interest is not authenticated if it is not written to the blockchain.

In yet another aspect of the disclosure, there is provided a method of non-fungible token (NFT) redemption including receiving a request for NFT redemption of a NFT of interest; retrieving utility information associated with the NFT of interest; determining if there are any unredeemed utilities associated with the NFT of interest; and notifying a user of any unredeemed utilities.

In another aspect, the disclosure includes receiving a request from the user to redeemed an unredeemed utility; notifying an owner of the NFT of interest of the utility redemption request; fulfilling the utility redemption request; and updated a database to reflect the redemption of an unredeemed utility. In yet another aspect, fulfilling the utility redemption request includes distributing the unredeemed utility to the user.

### BRIEF DESCRIPTION OF THE DRAWINGS

Embodiments will now be described, by way of example only, with reference to the attached drawings, in which:

FIG. 1 illustrates an embodiment of the system herein and an environment for the system;

FIG. 2a is a flowchart outlining a method of minting validated and collectible non-fungible tokens (NFTs);

FIG. 2b is a schematic diagram of validated non-fungible token (NFT) and collectible NFT creation;

FIG. 3a is a flowchart showing a method of NFT authentication;

FIG. 3b is a schematic diagram of NFT authenticity checking;

FIG. 4a is a flowchart showing a method of NFT redemption; and

FIG. 4b is a schematic diagram of NFT redemption.

### DETAILED DESCRIPTION

The disclosure is directed at a method and system for the providing trust and transparency relating to non-fungible token (NFT) ownership. NFTs may be used to protect creative works, intellectual property or real physical property. In the following description, use of the terms intellectual property or creative works will be interchangeable with real of physical property.

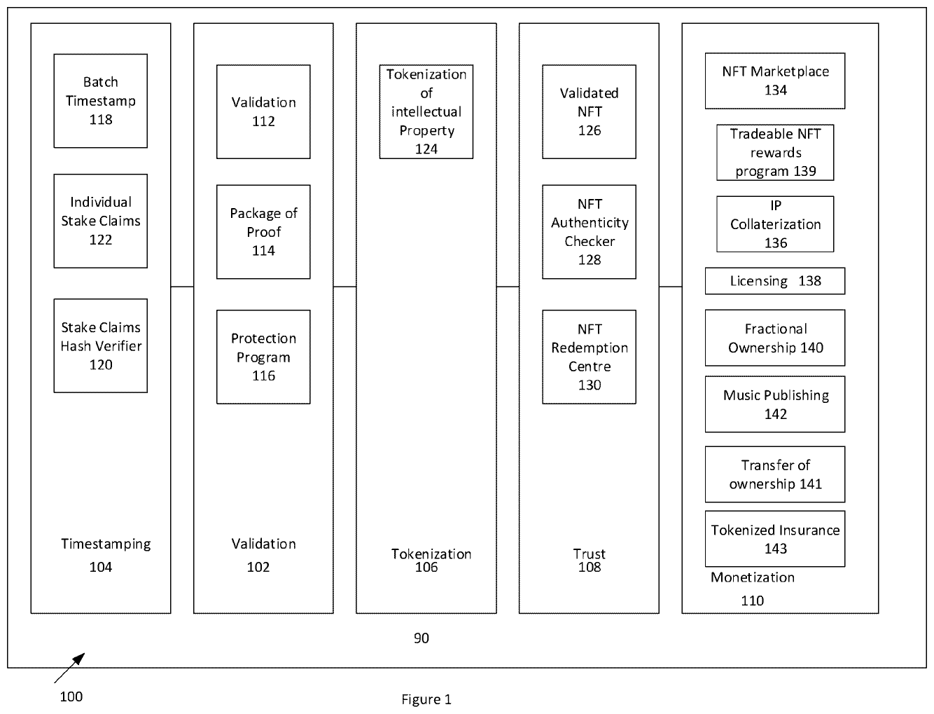

Turning to FIG. 1, a schematic diagram of a system for protecting, managing and/or monetizing creative works is shown. In one embodiment, the system 100 provides a process and functionality for creators to apply various levels of protection to their creative work, tools to verify the protection of that creative work, processes to provide ongoing monitoring of their creative work, and processes to monetize their creative work using a combination of traditional and blockchain technology. The system 100 may be stored or implemented via a server 90 (such as a web server) that may be in communication with a file server, a database and a blockchain. The system 100 includes at least one processor for executing a program or programs that implement the functionality described herein. In operation, a creator or user interacts with the system from a user computing device, such as, but not limited to, a computer or a smart device.

In the current embodiment, the system 100 includes a decentralized validation of intellectual property (IP), or validation, component 102; a decentralized timestamping of intellectual property, or timestamping, component 104; an enforceable and divisible tokenization of intellectual property, or tokenization, component 106; an encapsulating trust mechanisms into non-fungible tokens (NFTs), or trust, component 108; and a monetization component 110.

With respect to the timestamping component 104, the timestamping component 104 enables creators to post a permanent record (with a timestamp) of their creative work to the blockchain, in a short period of time, such as in minutes. The timestamping component 104 records the claim, or submission, of the creative work as a public, immutable record on a blockchain that the creator can use to prove the creative work is theirs. In one embodiment, the decentralized timestamping of intellectual property component 104 allow claims of ownership to be made quickly and inexpensively by creating, for example, a one-way hash of a submitted creative work on a blockchain (for example, a public blockchain such as Ethereum). This may be seen as a process of decentralized timestamping of intellectual property.

Once a claim of ownership is made, the blockchain will store immutable proof to secure the timestamp of submission. In the current embodiment, the decentralized timestamping of intellectual property component 104 includes a batch timestamp component 118, a stake claim hash verifier component 120 and an individual stake claims component 122. The batch timestamp component 118 and the individual stake claims component 122 may be seen as two modules, executing on the processor that is in communication with a blockchain, that may be able to perform the timestamping of intellectual property on, or to, the blockchain. In one embodiment, the decentralized timestamping of intellectual property component may enable creative works to be created as a record on the blockchain in a batch manner (via batch timestamp component 118) or individually (via individual stakes claim component 122). For the stake claim hash verifier component 120, a hashing function is used to verify the timestamps created from the batch timestamp 118 and/or individual stake claim 122 components. In a particular embodiment, only the hashed file or a zip file (which contains the creative work and other information) provided by the user will be able to generate the stored hash on the blockchain entry. This enables users to prove the claim/timestamp on the blockchain, including the date and time, the name of the user who created the timestamp, and other information. The timestamping component 104 may be seen as the first level of protection that a creator, or user, can use to protect their creative work.

With respect to validation component 102, the validation component 102 may be seen as a next level of protection after the timestamping component 104. The decentralized validation of intellectual property component 102 may include a validation determination component 112, a package of proof component 114 and a protection program component 116 (which may also be seen as a decentralized protection of intellectual property component). The validation determination component 112 may provide the functionality to allow creators of a creative work to increase protection of their creative work by validating the provenance of the creative work. Component 112 provides the functionality to validate the authorship, ownership, and originality, among other things, of an artist's creative work, such as in the form of a validation process. In one embodiment, the validation process may include interaction of the system, executing on the processor, with a team of global validators who work together in a gig-like fashion. In one embodiment, during the validation process, the decentralized network of certified validators may provide input to the system to validate the creative work based on validation criteria, such as, but not limited to, the point in time that the creative work was originated; the authorship and ownership of the creative work; and/or the uniqueness of the creative work. In one embodiment of the validation process, in a gig-like fashion, validators, that may be located globally, will be notified of an electronic creative work submission and the first certified validator(s) to accept the notification get the work. The results generated, or determined, by the validation determination component 112 may then be summarized in a Package of Proof (which may be generated by the package of proof component 114) that documents all steps taken to prove the authenticity of the creative work which may then be stored on the blockchain. The Package of Proof is a permanent, public record stored on the blockchain that the creator can use to prove the work is theirs.

The protection program component 116 may provide the functionality of decentralized protection of intellectual property. In one embodiment, the protection program component interacts with a set of protectors who search the internet and databases for unauthorized and/or unreported use of a creator's creative work and reports any such uses to the creator.

With respect to the protection program component 116, as part of component 102, the system may engage with a network of protectors, where the protectors may be located globally, to scour the digital and physical world for unauthorized and/or unreported use of protected creations. The network of protectors may then interact with the protection program component to assist the system in protecting the creative work from unauthorized use.

In one embodiment of use, the network of protectors may use internal and/or 3^{rd} party technology and databases to identify unreported and/or unauthorized use which is then input to the system via the protection program component 116. In one embodiment, this unauthorized use may be reported and action taken by the system such as, but not limited to, sending out demand letters with links to remedy via payment of a specified amount. In some cases, protectors may be engaged to perform routine monthly checks for unauthorized use. In other cases, the regular monitoring of unauthorized and/or unreported use of IP on platforms like ISPs, using component 116, can be seen as part of a due diligence process that ISPs may employ as part of their response to regulation and lawsuits dealing with copyright infringement on their platforms

With respect to the tokenization component 106, once a piece of creative work is validated through the validation component 102, the tokenization component 106 enables the tokenization of the creative work through non-fungible tokens (NFTs). In one embodiment, anyone can mint an NFT, whether they own the creative work or not. The system 100 and tokenization component 106 provides processes to mint NFTs that have been authenticated, or validated, by validation determination component 112, to generate validated NFTs. Only a creative work that has undergone validation, such as via validation determination component 112, will be minted as a validated NFT. Validated NFTs will include a reference to the Package of Proof generated by the package of proof component 114 and other important information to improve trust and transparency in NFTs. In the current embodiment, the tokenization component 106 includes an enforceable tokenization of intellectual property component 124. The tokenization component 106 leverages the strengths of blockchain technology while integrating and respecting the legal contracts required to make the ownership and transfer of NFTs enforceable. In some cases, validated NFTs will include relevant legal documents in the NFTs blockchain record, by way of hashing functions, to enable the transfer of NFTs in a manner that makes the transfer enforceable by the legal system. Tokenization of intellectual property component 124 also enables creators to mint child NFT(s) that are tied to the validated NFT. Child NFTs may also incorporate legal contracts, through hashing functions, to provide rights to the owners of the Child NFTs. In some cases, Child NFTs provide opportunities for monetization of the creative work, such as, for example, licensing, syndication, or the like.

With respect to the encapsulating trust, or trust component 108, the trust component 108 encapsulates trust with respect to the validated, or child, NFT. In one embodiment, the trust component 108 includes a validated NFT component 126, a NFT authenticity checker component 128, and a NFT redemption centre component 130. The encapsulation of trust component may provide trust and transparency to owners, buyers and sellers of NFTs. The encapsulation component 108 may provide the functionality to mint a validated NFT and to then, if desired, mint a collectible NFT associated with the validated NFT. These collectible and validated NFTs may be authenticated by the encapsulation component so that purchasers of these NFTs may have confirmation that they are purchasing an authentic NFT. The NFT authenticity check components 128 and the NFT redemption centre component 130 may be seen as tools that an owner, buyer or seller of NFTs can use to confirm the authenticity of the NFT and confirm information regarding the status of utilities associated with the NFT.

With respect to the monetization component 110, while components 104 (timestamping), 102 (validation), 106 (tokenization), and 108 (encapsulating trust) provide the user with the functionality or processes to protect and tokenize their creative work, the monetization component 110 provides a process for creators to monetize their creative work. In the current embodiment, the monetization component 110 includes a NFT marketplace component 134, an IP Collateralization component 136, a licensing component 138, a fractional ownership component 140, a tokenized tradeable rewards component 139, a transfer of ownership component 141, a tokenized intellectual property insurance component 143 and a music publishing admin (MPA) component 142. The monetization component may provide the functionality for a creator who owns validated creative work, a validated NFT and/or child NFT to monetize their creative work. These monetization processes are enabled by component 110 via its integration with components 104, 102, 106 and 108. The monetization component 110 may provide a plurality of different options for a creator to select and then guides the creator through the process to monetize the creative work in the selected manner. For example, by utilizing results generated by the validation component 102 and tokenization component 106, this may provide important information about the NFT and the associated creative work to an individual or corporation to collateralize the NFT or underwrite insurance on the NFT (using tokenized intellectual property insurance component 143). In another example, utilizing validation component 102, tokenization component 106, and trust component 108, a NFT marketplace (component 134) may provide more trust and transparency to NFT transactions.

The present disclosure provides systems and methods for encapsulating trust and transparent into NFTs and relates to the trust component 108 in FIG. 1. In one embodiment, the disclosure is directed at a system and method for encapsulating trust mechanisms into NFTs related to creative works, such as copyrights, however, the disclosure may be applied to other forms of intellectual property as well as other types of property. Examples of intellectual property include, but are not limited to, patents, trademarks or industrial designs and examples of other property include, but are not limited to, transactions of physical or virtual property (i.e. land or residential/commercial properties), tickets to entertainment events (i.e. concerts or sporting events) and all other transactions that can be facilitated using NFTs.

An NFT may be seen as a set of “tokens” which can represent any property (digital or physical) such that each token is unique. In one embodiment, NFTs exist, or are stored, on a blockchain, which may be seen as a digital ledger, and are represented by a set of functions and controlled data. NFTs can be used to represent items such as photos, videos, audio, and other types of digital files. Often, NFTs have utilities associated with them whereby, when a buyer purchases the NFT (or a version of the validated version of the NFT), the buyer may also receive a utility such as, but not limited to, merchandise, special access passes, etc.

In one embodiment, the system and method of the disclosure may be supported by the Ethereum network and associated with ERC-721 and ERC-1155 standards, otherwise known as 721 NFTs and 1155 NFTs, respectively. The ERC-721 standard represents an interface (a set of functions that do specific tasks), which allows for many unique NFTs to be created. NFTs that use or are created by the ERC-721 standard allow external applications (or processors) to interact with the NFT (such as in the form of a smart contract) without changing their implementation due to the adherence to the standard.

There are many differences between the ERC-721 and ERC-1155 standards whereby the desired use or application of the NFTs may determine which standard is selected. One difference is that ERC-721 tokens are singular whereas ERC-1155 tokens may be finitely divisible. The ability for ERC-1155 tokens to be divisible makes these tokens semi-fungible. Both standards have extensions to their base tokens which adds useful features to their smart contracts, and thus to the DAPPs that interact with the NFTs. Both types of NFTs have extensions that support adding extra metadata to each unique token.

For instance, with 721 NFTs, the function is represented as tokenURI (tokenID) and for 1155 NFTs, the function is represented as uri (tokenId). These functions can either return a json string or a URL which points to a JSON string. The disclosure utilizes the URL to point to controlled servers while the metadata is used to help visualize an NFT token on a marketplace and provides information such as, but not limited to, description, external URL, image/video, name, and other marketplace specific attributes.

In the following, the specification will refer to ERC-1155 smart contracts as NFTs, as is standard industry practice, however, it is understood that other types of standards are contemplated.

In accordance with the disclosure, it is desirable to provide an improved system where buyers, sellers and corporations have systems and tools to determine that an NFT and its associated creative work is authentic, among other things.

In one embodiment, the disclosure assists in providing trust for purchasers of a piece of property that is stored within a NFT. By integrating trust mechanisms with a NFT associated with the property, authenticity of the property being purchased can be provided. In some embodiments, the disclosure may assist to answer questions such as: 1) How does a buyer know that the seller is the owner of the creative work and the utilities associated with the NFT?; 2) How does an NFT owner prove their rights if a dispute arises?; 3) How does the buyer know that the creative work associated with the NFT is original? and/or 4) How does the buyer know if utilities associated with the NFT are still valid?

The systems and methods provided in this disclosure may include different components, such as, but not limited to, (1) the Validated NFTs component 126, (2) a Collectible NFTs component, (3) the NFT Authenticity Checker component 128 and (4) the NFT Redemption Centre component 130. As described below, the components may individually and/or collectively improve the transparency and functionality of NFTs.

The validated NFT component (see as 126 in FIG. 1) may be seen as a module that generates an NFT that has had its contents validated as authentic and/or true such as by the validation component 102. This may be performed in many ways, such as being authenticated by a group of individuals who have reviewed the contents, authenticated by government bodies that have authenticated the contents, signed documents from an owner who attests to its authenticity and other ways. The validated NFT may be used to improve trust and transparency in NFTs as will be discussed in more details below.

In contrast to most NFTs sold on marketplaces today, a validated NFT allows for key information to be stored within the validated NFT and/or hashed in the NFT record when it is minted by a NFT smart contract component. While the minting of NFTs by a NFT smart contract will be understood, minting of a validated NFT in accordance with the disclosure includes aspects or features that are not currently known.

For copyrights, these aspects may include, but are not limited to, storing information on the blockchain related to the copyright of the creative work associated with the NFT and the connection between collectible NFTs and validated NFTs. In one embodiment, a validated NFT may represent ownership of the underlying creative work associated with the NFT (musical works, literary works, visual works, etc.). In another embodiment, the validated NFT may contain details about the creator, the date of the creation, the ownership (fractional or whole) of the creative work, and a hash of supporting documents that support authorship, ownership and originality details. By contrast, many NFTs that are currently sold only include a copy of the creative work, with no ability to verify whether the NFT and its associated creative work are authentic or authorized by the owner of the underlying work.

Other systems and methods of validating a NFT are disclosed in U.S. Provisional Application No. 63/139,092 filed Jan. 19, 2021 entitled System and Method for Protecting, Managing and Monetizing Creative Works which is hereby incorporated by reference.

The choice of using ERC-721 or ERC-1155 NFTs may be determined by the creator of the validated NFT component 126. In one embodiment, validated NFTs are 1155 NFTs because each validated NFT can support part ownership, which may be represented by minting a predetermined number of a new validated NFTs. In one embodiment, 100 validated NFTs may be minted (which may be seen as 100 shares), but the owner of the creative work can choose any number they wish to subdivide ownership of their creative work.

A collectible NFTs component (or collectible NFT) may be seen as an NFT that is based on, and associated with, a parent validated NFT. Custom data may be added to the collectible NFT to link the collectible NFT to its parent validated NFT and to store additional information. The collectible NFT component may be generated by a collectible NFT smart contract tool or module. Collectible NFTs can provide the ability for a creator or owner of the parent validated NFT to sell copies of their creative work without selling the copyright to it. Unlike NFTs that currently exist, the collectible NFT ties back to, or is associated with, the parent validated NFT to ensure the individuals in the transaction for the collectible NFT can verify the authenticity of the collectible NFT. Using the system of the disclosure, when a collectible NFT is minted, it references the parent validated NFT. Within the smart contract embedded or integrated within the collectible NFT, only trusted partners are able to mint/deploy collectible NFTs, and the provided system and method stores the address and token id for the minted parent validated NFT. The collectible NFT smart contracts tool or module assigns ownership and manages the transferability of the collectible NFT's.

As discussed above, when the collectible NFT is generated, it is associated with, or tied to its parent validated NFT. The collectible NFT may also be connected or attached to utilities, such as merchandise and/or experiences that are connected to the parent validated NFT. The collectible NFT provides a mechanism for the buyer to see and understand the status of utilities associated with the NFT. In one embodiment, a user can verify the utility redemption status and redeem NFTs through the NFT Authenticator component and/or a NFT Redemption Centre component as discussed below. The collectible NFTs may be either a 721 NFT or a 1155 NFT.

The provided disclosure discusses the features of validated NFTs and collectible NFTs only as they pertain to encapsulating trust mechanisms into NFTs.

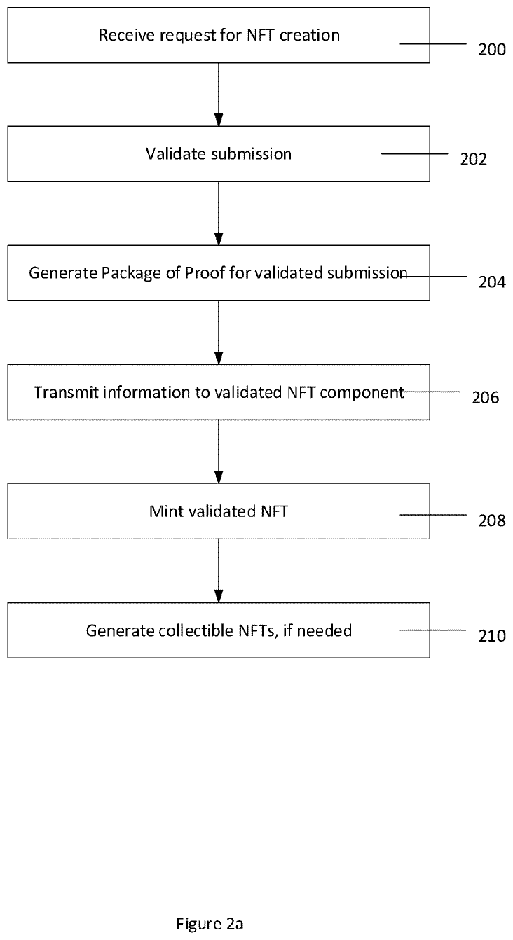

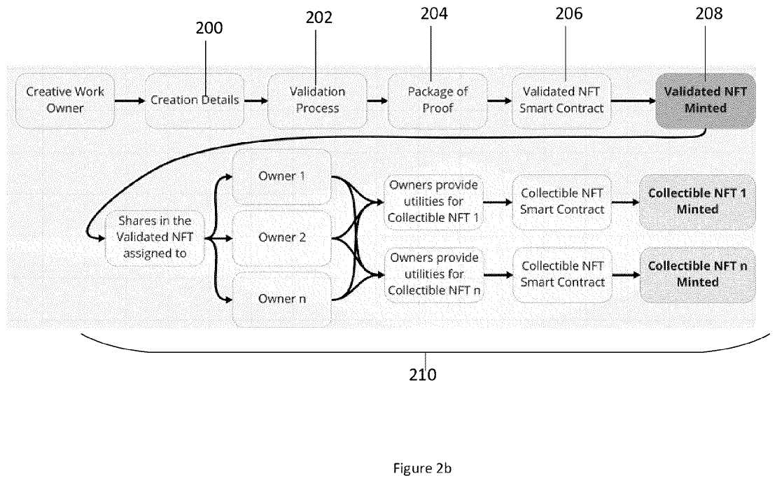

Turning to FIG. 2a, a flowchart outlining a method for minting validated and/or collectible NFTs is shown.

Initially, the owner of the creative work uploads the details about the creation, or creative work, and its ownership, and the utilities associated with the desired NFT to the system of the disclosure, which is received by the system (200). This may be seen as a submission that is received by the system where the submission is a request for NFT creation. The system then performs a validation process (202) of the creative work associated with the submission to verify characteristics of the creative works such as, but not limited to, authorship, ownership, and originality. If validated, the system then generates a package of proof (204) which documents the validation process. Generation of the package of proof may also enable a validated NFT to be generated since validation of the work means that the system has verified that the owner is the original creator of the creative work and that it is authentic and original. The package of proof, among other information, is then sent to a validated NFT smart contract component (206) which may be the validated NFT component 126 of FIG. 1. In one embodiment, the other information may include at least one of an identification (ID) number; the owner's information (such as owner address, owner name); the number of shares to be created; the name of the creator(s) (which may be the same as the owner); the creation date; a file to hash, including the original creation file and/or a zip file of the package of proof; and/or a payment plan for purchase of part or all of the NFT or any collectible NFTs associated with the validated NFT.

A new validated NFT is then minted by the validated smart contract component or validated NFT tool (208). In one embodiment, the validated NFT may be minted with a single share or ownership (when using the 721 standard or the 1155 standard). In another embodiment, the validated NFT may be minted with a predetermined number of, such as X, shares (when using the 1155 standard) so that fractional ownership of the NFT may be provided, if desired as the 1155 standard allows for the minted tokens to be proxy for shares thereby making the NFT divisible. In one embodiment, the distribution of shares is minted for each owner associated with the validated NFT as listed on the validated NFT smart contract so that an owner can sell any amount of their shares of the validated NFT, which would transfer part ownership in the underlying creative work to the buyer. Each validated NFT with multiple shares is created such that its proportional ownership may be represented as shares. An owner of the validated NFT can also sell a portion of their ownership in the NFT through the sale of shares. For example, with 100 shares available, if an owner sells 30 shares in the validated NFT, the third party buyer then owns or controls 30% of the validated NFT. The system may then generate collectible NFTs based on the validated NFT (210).

Turning to FIG. 2b, another embodiment of a method for minting validated and collectible NFTs is shown. FIG. 2b provides further details with respect to one embodiment of minting collectible NFTs such as disclosed as 210 in FIG. 2a.

Assuming n owners of shares in the validated NFT, the owners may provide input with respect to utilities that may be associated with a collectible NFT. This utility information is received by the system and stored accordingly. The utility information and other information stored within the validated NFT is then transmitted to a collectible NFT smart contract component for generating a collectible NFT. In other embodiments, to generate the collectible NFTs, there may be no utilities and therefore information associated with the validated NFT is transmitted to the collectible NFT Smart contract component or collectible NFT tool which then mints the Collectible NFT. In some embodiments, the collectible smart contract component may be the same as the validated NFT smart contract component 126. The collectible NFT is then minted by the system with the information provided.

Through the collectible NFTs, copies of the creative work can be sold without transferring the underlying ownership in the creative work such that the owner of the validated NFT can mint new collectible NFTs. In another embodiment of the system, the system must receive confirmation or instruction from a majority of owners of the validated NFT before an action is taken. It is understood that a collectible NFT cannot be minted before a validated NFT is minted, however, once a validated NFT is minted, collectible NFTs can be minted at any time.

In order to assist in providing trust encapsulating trust mechanisms within the NFTs, the validated NFTs and collectible NFTs contain information or data that may be required to facilitate NFT transactions that incorporate trust for users. Information that is stored in the validated NFTs and/or collectible NFTs provide a prospective buyer the ability to analyze the NFT prior to purchase or sale.

In one embodiment, the systems and methods provided in this disclosure provide the prospective buyer with the ability or functionality to analyze characteristics or properties of the creative work of the validated or collectible NFT's. These characteristics may include its authenticity, its copyright and holder or owner rights. For the purposes of explanation, these three characteristics and the system and method for analyzing the characteristics are discussed in detail below.

With respect to authenticity, since NFT fraud is widespread, an individual can copy a creative work associated with an existing NFT, mint a new NFT that looks almost identical to the original NFT, and then list it for sale whereby an unsuspecting buyer may purchase a fraudulent NFT. In an example, an individual, John Doe, could mint an NFT based on their original creative work and post it for sale. Another individual can download the creative work associated with the NFT, mint an NFT and list it under John Dohe in an attempt to trick a buyer. By using a validated NFT (and one that may be checked for its authenticity), a buyer may have more confidence or trust in purchasing that NFT as it has been validated as authentic and that validation can be checked or confirmed by the system to the buyer as will be described below. In other words, one aspect of the disclosure is directed at the generation of a validated NFT that was minted by a smart contract approved by the owner of the creative work that can then be authenticated.

With respect to copyright, this provides an exclusive legal right to an individual to print, publish, perform, film, or record literary, artistic, or musical material, and to authorize others to do the same. The copyright is associated with an intangible legal intellectual property right associated with the author of the tangible copyright creation. In one aspect of the disclosure, the disclosure provides a method and apparatus for providing users with the ability to verify whether an NFT has been validated from a copyright perspective as will be discussed below.

With respect to holder rights, there are often utilities associated with an NFT transaction whereby the seller provides the buyer of the NFT with additional goods or services in addition to the NFT. However, since an NFT can be sold multiple times, some of those goods or services could have already been claimed. In one aspect of the disclosure, the disclosure provides a method and apparatus for providing users with a way to determine what utilities remain associated with an NFT and provide the user with functionality to redeem the utilities as will be discussed below.

In one embodiment, the system includes an NFT Authenticity Checker or Centre seen as component 128 of FIG. 1 that provides the user, whether an NFT buyer, seller, or owner, with the functionality to determine authenticity, copyright and/or holder rights, as described above.

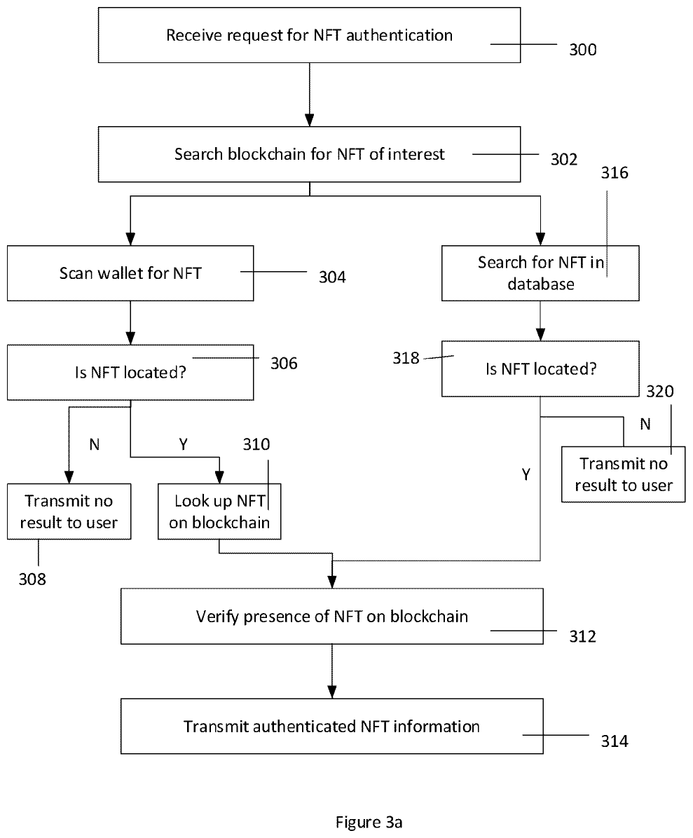

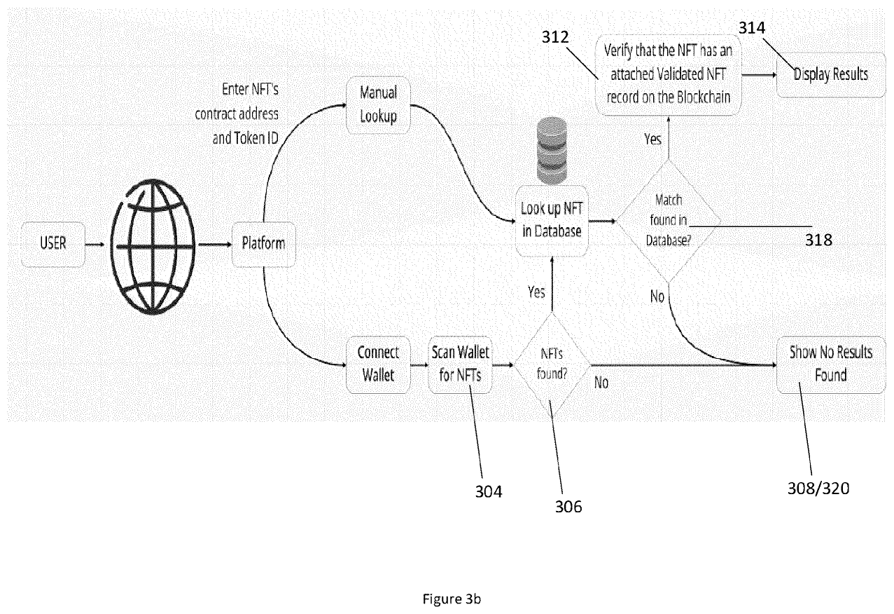

Turning to FIG. 3a, a flowchart outlining one method of NFT authentication is shown. Initially, the system, or the NFT Authenticity Checker 128 receives a request from a user (300). The request may be in the form of a request to check at least one of the authenticity, copyright or holder rights for a validated and/or collectible NFT. In one embodiment, the request may be initiated by the user connecting their digital wallet to the system or by the user entering or inputting the NFT's contract address and token ID into the system. The system then searches the blockchain for the NFT of interest (302).

In one embodiment of searching where the user connects their wallet, the system scans the blockchain within the wallet for the NFT of interest (304). The scanning may include searching the crypto wallet for a NFT's smart contract address and token ID. The system then determines if an NFT is found (306). If the NFT is not found, the system will return a response of No Results to the user (308). If a NFT is found, the system looks up the NFT in a database associated with the system (310). The system verifies that the NFT has a record on the blockchain and/or within the system (312) and that it is validated. The system may then transmit or display the information associated with the NFT (314) which provides proof of the NFT's authenticity, copyright and holder rights.

Alternatively, if the user enters the NFT's contract address and token ID, the systems looks up the NFT in the database (316) and determines if the NFT is found (318). If the NFT is not found, the system will return a response of No Results to the user (320). If the NFT is found, the system verifies that the NFT has a record on the blockchain and/or within the system (312) and that it is validated. The system then displays the information associated with the NFT (314) which provides proof of the NFT's authenticity, copyright and/or holder rights.

In one embodiment, for authenticity, the proof may include documentation of the smart contract on which the collectible NFT was minted, providing proof that the collectible NFT is tied or associated with the owner of the validated NFT which may provide authenticity information that the collectible NFT was not minted on a smart contract owned by someone other than the NFT owner. This authenticity information may show that the collectible NFT is connected to or associated with the validated NFT and that the collectible NFT is authentic. This may be displayed to a user or the system may provide a print out to the user.

In another embodiment, for copyright, the proof may be a link to the package of proof that is associated with the NFT. As outlined above, the package of proof documents all of the steps taken to validate the NFTs authorship, ownership and originality, among other things. This provides the user with the ability to verify that the copyright of the creative work associated with the collectible NFT they are purchasing belongs to the seller of the collectible NFT. This link may be stored in metadata or hashed into the NFT.

In another embodiment, to determine holder rights, a hashed record of the utilities associated with the NFT (including the redemption status of each) may be stored on the blockchain. This provides confirmation to the user if the NFT they own or are buying has utilities associated with it that they can access (i.e. that they are not redeemed). In some cases, the value of the NFT may be dependent on the utilities associated with it. This may be displayed to a user via a summary page or via a contract associated with the NFT.

The transmission or display of either No Results or authenticated NFT information provide the user with valuable information to assess the authenticity of the NFT that they are considering purchasing or obtaining.

FIG. 3b provides a schematic diagram of another embodiment of operation of an NFT Authenticity checker component.

One advantage of the disclosure is that there is a reduction in centralization whereby if a centralized third party ceases to exist, the owner of the creative work is still able to prove ownership and rights to the creative work. For example, to administer the addition of the legal contract/document's hash into a validated NFT requires some level of centralization or a trusted third party. In order to overcome the centralization issue, the owners of the creative work can: (i) download or otherwise obtain the hash function used to create the hash of the legal contract/document and (ii) retain the source document (in the form of a digital copy) of the legal file used to generate the hash. This way, even if the trusted third party ceases to exist, the owner can prove their ownership stake with the blockchain record, the legal file, and the one-way hash function used. If this hash matches the record found on the blockchain, this provides proof that the legal contract/document used to generate the hash is enforceable because only the specific legal contract/document can generate a hash to match the record on the blockchain. For buyers, for example, each NFT buyer receives and retains a copy of the source contract (the same as used to generate the hash). In the future, in cases where the owner/buyer needs to prove that they are the owner of the NFT, they can use that source contract, hash it, and show that the hash generated matches the hash in the NFT record.

In one embodiment, the NFT redemption centre component 130 provides the user with the functionality to obtain information about utilities associated with an NFT (either validated or collectible) and to redeem all or some of the utilities, where possible. The NFT redemption centre component may enable users to see the utilities of the NFT and their respective redemption statuses. In one example, by using this tool, the user can verify if the NFT they are purchasing has certain utilities remaining, which would be an important piece of information when determining how much to pay for a NFT. Under another embodiment, the component enables users to input information, for example their home address or crypto currency wallet address, into the system, in order to allow the user to redeem utilities such as, but not limited to, merchandise, physical art, experiences, coupons, digital downloads and crypto currencies. Under another embodiment, the tool may connect corporate users such as, but not limited to, ticketing organization or retailers to their customers. The tool provides information to corporate users such as when and where to ship physical merchandise; who and when a customer would like to have an experience with a celebrity; or information about coupon codes that the user is eligible for upon purchase of a good or service.

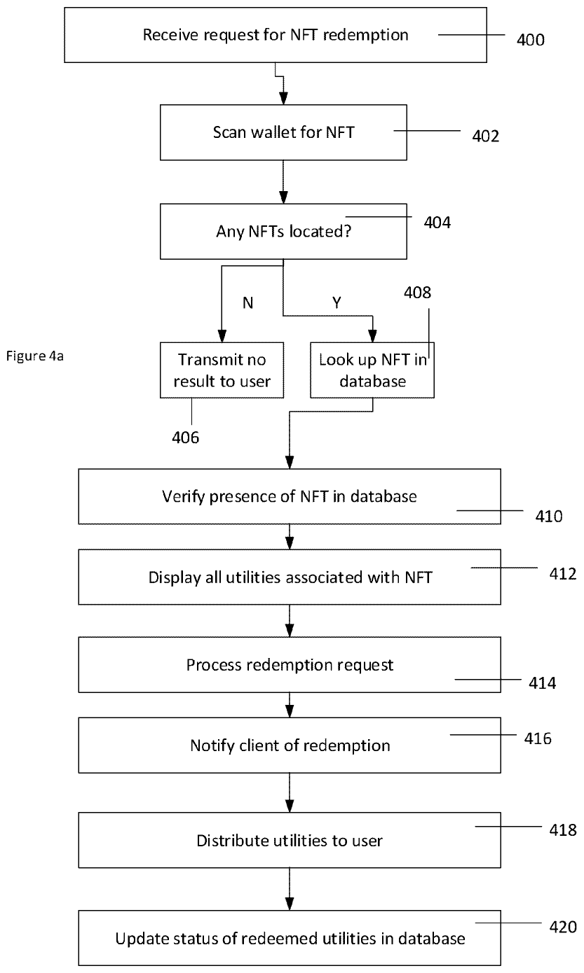

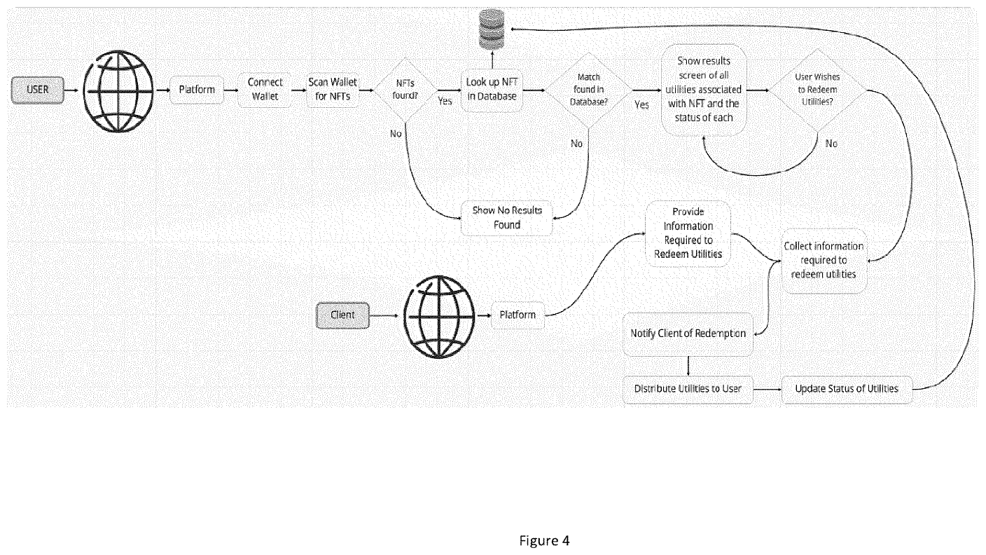

FIG. 4a is a flowchart showing one method of NFT redemption and FIG. 4b is a schematic diagram of an embodiment of the NFT Redemption Centre component and method in combination. As shown in FIG. 4b, there are typically 2 parties that access the NFT redemption component, the user and the client. The client may be seen as the owner of the validated NFT that minted the Collectible NFT and provided the associated utilities and the user is the person interested in learning more or purchasing the validated or collectible NFT. In order to facilitate the redemption of utilities, the client provides a set of predetermined information before it is able to collect payment from the user. After purchasing the collectible NFT, the user is provided access to the system to either view or redeem utilities.

Initially, the NFT Redemption Centre receives a request from a user (400). The request may be in the form of a request to redeem a utility associated with a NFT. In one embodiment, the request may be initiated by the user connecting their digital, or cryptocurrency, wallet to the system. The system scans the wallet for NFTs (402) to determine if there are NFTs stored in the wallet (404). If there is no NFT found, the system notifies the user that there is no NFT in the wallet (406). If NFTs are found, the system looks up the NFT in the database (408). The system then determines if there is a NFT match is found in the database (410), and displays all utilities associated with the NFT (412) and the status of each utility if a match is found.

If the user wishes to redeem their utility, the user inputs or provides information required for redemption to the system which is processed by the system (414). For example, if a utility is a type of merchandise, the user may input their home address for shipment of the merchandise to their home. In another example, if a utility is a specific number of cryptocurrency tokens, the user may input the wallet address they would like to have the tokens delivered to and the system performs the necessary actions to deliver the tokens.

After all the required information is collected from the user, the system notifies the client of the redemption (416) and the utilities are distributed to the user by the user (418). This distribution may be done automatically by the system or completed by the client via the system or manually performed after being noticed by the system. After distribution and confirmation of receipt of the utilities, the system updates the status of the utility in the database (420). In one embodiment, the system provides an update of the metadata associated with the NFT.

If the user decides to only redeem a portion of the utilities, the user may resell the collectible NFT to someone else who could then login to the platform and redeem a different utility such as in a manner similar to the process discussed above. The metadata keeps track of the redemption status of each utility. The hashed terms on the blockchain proves the terms that were originally conveyed with the NFT sale. In one embodiment, the utility statuses can be updated on the blockchain to keep all proof on chain.

In the preceding description, for purposes of explanation, numerous details are set forth in order to provide a thorough understanding of the embodiments. However, it will be apparent to one skilled in the art that these specific details may not be required. It will also be understood that aspects of each embodiment may be used with other embodiments even if not specifically described therein. Further, some embodiments may include aspects that are not required for their operation but may be preferred in certain applications. In other instances, well-known structures may be shown in block diagram form in order not to obscure the understanding. For example, specific details are not provided as to whether the embodiments described herein are implemented as a software routine, hardware circuit, firmware, or a combination thereof.

Embodiments of the disclosure or elements thereof can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with other modules and elements, including circuitry or the like, to perform the described tasks.

The above-described embodiments are intended to be examples only. Alterations, modifications and variations can be effected to the particular embodiments by those of skill in the art without departing from the scope, which is defined solely by the claim appended hereto.

What is claimed is:

1. A method of encapsulating trust mechanisms within a non-fungible token (NFT) comprising:
receiving a request for generating a NFT of an item;
validating the item;
generating a validated NFT based on a positive validation of the item; and
writing the validated NFT to a blockchain.

2. The method of claim 1 further comprising:
generating at least one collectible NFT based on the validated NFT; and
writing the at least one collectible NFT to the blockchain.

3. The method of claim 1 further comprising, after validating the item, generating a package of proof based on the validation.

4. The method of claim 3 wherein when the item is a creative work, generating a package of proof comprises:
combining the creative work, supporting documents and validation information into the package of proof.

5. The method of claim 4 wherein generating a validated NFT comprises:
transmitting the package of proof to a NFT validated smart control component; and
generating the validated NFT based on the package of proof.

6. The method of claim 2 wherein generating at least one collectible NFT based on the validated NFT comprises:
receiving utility information associated with the validated NFT; and
generating a collectible NFT based on the utility information and a package of proof.

7. A method of authenticating a non-fungible token (NFT) of interest comprising:
receiving a request for authenticating the NFT of interest;
determining if the NFT of interest is written to a blockchain and validated; and
displaying proof to a user of NFT authenticity if the NFT is written to the blockchain and validated.

8. The method of claim 7 wherein receiving a request for authenticating the NFT comprises:
sensing connection of a cryptocurrency wallet; and
searching the cryptocurrency wallet for the NFT of interest.

9. The method of claim 7 further comprising providing notification to a user that the NFT of interest is not authenticated if it is not written to the blockchain.

10. A method of non-fungible token (NFT) redemption comprising:
receiving a request for NFT redemption of a NFT of interest;
retrieving utility information associated with the NFT of interest;
determining if there are any unredeemed utilities associated with the NFT of interest; and
notifying a user of any unredeemed utilities.

11. The method of claim 10 further comprising:
receiving a request from the user to redeemed an unredeemed utility;
notifying an owner of the NFT of interest of the utility redemption request;
fulfilling the utility redemption request; and
updated a database to reflect the redemption of an unredeemed utility.

12. The method of claim 11 wherein fulfilling the utility redemption request comprises:
distributing the unredeemed utility to the user.

13. The method of claim 1 wherein generating a validated NFT based on a positive validation of the item comprises:
minting the validated NFT with legal documents or utilities associated with the validated NFT.

14. The method of claim 1 wherein generating a validated NFT based on a positive validation of the item comprises:
minting the validated NFT with a predetermined number of shares to allow for fractional ownership rights.
